(19) United States
(12) Patent Application Publication
(10) Pub. No.: US 2016/0145081 A1
(43) Pub. Date: May 26, 2016

(54) INTELLIGENT MOTOR BRAKE FOR A LENGTH/ANGLE SENSOR OF A CRANE

(71) Applicant: HIRSCHMANN AUTOMATION AND CONTROL GMBH, Neckartenzlingen (DE)

(72) Inventor: Leo PETRAX, Marxzell (DE)

(21) Appl. No.: 14/902,936

(22) PCT Filed: Aug. 14, 2014
(86) PCT No.: PCT/EP2014/067442

§ 371 Date: Jan. 26, 2016

(30) Foreign Application Priority Data
Aug. 15, 2013 (DE) 10 2013 216 246.4

(51) Int. Cl. B66C 23/90; G01B 7/02; B66C 13/22; B65H 75/44; B66C 23/70

(52) U.S. Cl. CPC B66C 23/90; B65H 75/4486; B66C 23/701; B66C 13/22; G01B 7/026

(57) ABSTRACT

The invention relates to a length sensor, in particular a length/angle sensor (10) of a crane (1), having a rewinding system and having a reel and a cable that is wound onto the reel and can be unwound from the reel in order to detect a length, characterized in that the rewinding system comprises a controllable electric motor.

The invention relates to a length sensor, to a method of operating a length sensor, and to a crane in which such a length sensor is used, according to the features of the introductory clause of the independent claims.

Sensor components with integrated safety electronics for modern mobile machinery, such as cranes or excavators, are developed according to industrial safety standards EN 61326 and IEC 61508.

Information from numerous sensors, among other things, is required for the stable operation of a crane. Multiple lengths, different angles, pressures, and forces are measured and calculated in a comprehensive mathematical model. Subsequently, this model is analyzed for instabilities and safety margins, and corresponding recommendations, suggestions or direct reactions are initiated and monitored.

A crane comprising a base having a pivotable and telescopic boom assembly that has a plurality of boom elements is known from DE 10 2012 221 909 A1, where a length/angle sensor is provided that comprises at least one cable that detects the respective length of the telescopic boom assembly and a force sensor operatively associated with the cable detects the tension in the cable.

It is the object of the invention to provide a length sensor, in particular a length/angle sensor of a crane, a method of operating such a length sensor, and a use of it in a crane that are improved over purely mechanical spring systems for generating the return force of the rewinding system.

This object is achieved by the features of the independent claims.

With respect to the length sensor, in particular the length/angle sensor, according to the invention the rewinding system comprises a controllable electric motor. While a spring is provided for generating the return force in a purely mechanically acting rewinding system, according to the invention this force is created by a controllable electric motor. In this way, the return force can be positively influenced by corresponding activation by a controller in a targeted manner. Due to the activation of the electric motor, it is possible for example that the cable is always wound onto the reel, or unwound from it, with a constant, preferably a substantially constant, force when the telescopic boom assembly on a crane is being extended or retracted. Due to this virtually constant force acting on the cable, regardless of how far this cable is wound onto the reel or unwound from the reel, wear can be considerably reduced during operation. The electric motor is activated in such a way that it acts on the reel as a drive motor, for example during winding, while it acts as a generator when the cable is being unwound from the reel. Of course, the motor may also act as a generator when the cable is being unwound from the reel.

Such length sensors are typically compact assemblies with all its parts in a housing. In the length sensor according to the invention, the drive shaft of the motor is thus either directly on the axle as the reel, or the motor is indirectly connected to the reel via a gearbox. Depending on design, power and the like of the motor, it lends itself to connect it to the reel directly or indirectly via a gearbox. The direct connection of the motor to the reel has the advantage of a particularly compact design, so that consequently also the entire housing of the length sensor can have a compact design. The indirect connection of the motor to the reel via a gearbox has the advantage that the motor can be controlled, and thus the force acting on the cable can be set, with considerably greater sensitivity. Moreover, it is possible in both cases (direct connection of the drive shaft of the motor to the axis of the reel or indirect connection) for the motor to ensure that, when winding the cable onto the reel, the force necessary for winding the cable onto the reel is available.

In a refinement of the invention, the length sensor has a dedicated power supply. The motor is typically supplied via an external power supply, as is the controller for activating it, for example that of a crane or the like. However, if this power supply fails, the dedicated power supply of the length sensor may be used to operate at least the motor, but if necessary also the controller. This is particularly important from safety aspects, especially in cranes.

To achieve the object, a method of operating a length sensor is provided, and the rewinding system comprises the controllable electric motor already described, and the motor is activated such that a predetermined force progression of the cable is obtained when it is being unwound from the reel and/or wound onto the reel. Appropriately activating the motor, thus ensures that the cable that for example determines the length of a telescopic boom assembly of a crane when this boom is being retracted or extended, always has the same mechanical tension so as to detect the length of the telescopic boom assembly as precisely as possible.

In one refinement of the invention, the motor is activated such that a virtually constant tension is maintained in the cable when it is being unwound from the reel and/or wound onto the reel. This constant, in particular virtually constant, force progression of the cable ensures that it is always set to the same mechanical tension within the cable between the two end points between which the telescopic boom assembly is able to move. This, in particular, advantageously prevents the cable, which is usually arranged approximately parallel to the telescopic boom assembly, from sagging or from sagging appreciably.

So as to compensate for a length imprecision due to sagging of the cable at longer lengths of the telescopic boom assembly, it may be considered to activate the motor in such a way that the force on the cable is increased by a corresponding activation of the motor as the length increases, which is to say as the telescopic boom assembly is being extended further. In this way, the cable is tensioned proportionately and sagging is prevented. The corresponding activation of the motor may be carried out by a controller and may also be considered when the length of the unwound cable, and thus the length of the extended telescopic boom assembly, is being determined.

In one refinement of the invention, a force sensor is used to measure the force acting on the cable. This has the advantage that, due to the force measurement, it is not only possible to appropriately activate the motor, but also to determine whether or not the cable is sagging as it is wound up or payed out. As the cable is increasingly unwound from the reel, sagging of the cable (that, as was already explained, is virtually parallel to the telescopic boom assembly of the crane) develops, so that a higher force must be set to prevent this sagging as the extension of the telescopic boom assembly is increased. Due to the correlation of the measured force and the activation of the motor, this ensures that the cable does not sag, or does not appreciably sag, in the as it is payed out. In addition, the force measurement ensures that problems when paying out the cable from and/or winding it up onto the reel are identified. In particular, a cable break or a cable jam can thus be detected with high precision. If the measured force then abruptly decreases, it is possible to detect that a cable break is present. However, if the force acting on the cable increases above a predetermined threshold value, it is to be assumed that a cable jam exists. This may be accordingly detected by the force measurement and a response may be initiated, which is again particularly important in the operation of cranes from a safety perspective.

In one refinement of the invention, further operating parameters are considered for the motor. These operating parameters are parameters of the controller used to detect the length by the length sensor. A typical example is a crane having a telescopic boom assembly, and the length of the telescopic boom assembly changes in that a fixed lower boom element is provided and, starting therefrom, at least one further element is telescopically extended or retracted. The motor can be appropriately activated depending on the operating mode of the crane.

As described above, the invention is based on a length sensor that comprises the reel from which the cable can be unwound, or onto which the cable can be wound, so as to, based thereon, determine the wound or unwound length of the cable, and this length is a measure for a further element, in particular the telescopic boom assembly. However, in practice it has proven useful to use not only the previously purely mechanically acting length sensors having mechanically acting rewinding systems alone, but to integrate an angle sensor into these as well. The angle sensor is used to measure the angle of the telescopic boom assembly by which the boom, starting from the base, is moved out. However, the integration of both the angle measurement and the electrically acting rewinding system according to the invention into a length/angle sensor is particularly advantageous. All necessary elements for this purpose, in particular the angle sensor itself, the reel, the motor and other necessary elements, are accommodated in a housing that can be mounted in a suitable location on the crane, in particular on the telescopic boom assembly thereof.

The invention thus is an intelligent motor brake for a length/angle sensor as a replacement solution for a mechanical spring system. As already mentioned above, previous length/angle sensors used purely mechanical spring systems to generate a return force. Such a typical rewinding system is intended to ensure an approximately constant force progression and operational stability behavior both with respect to environmental influences and safety requirements.

An electric, parameterizable solution is sought that responds flexibly to changing requirements of the application and helps reduce both cost and weight. It is also possible for multiple projects to exist in this area, among other things in the direction of concept creation (key word: simulation models), solution design, and implementation with subsequent evaluation.

Description of the idea:
Reproduction of the characteristic curve “force progression—spring system” with the aid of an “intelligent” electric motor.
“Identification” of the crane states (forward, backward, stop, off, and the like) and definition of corresponding profiles for the brake (slow, fast, testing, stopping, and the like).
Determination of cable length by retraction to a defined point and simultaneous length measurement (potentially as a separate idea).
Safety aspects such as identification and counteraction in the event of a cable break or cable jam (“impulse test”).
Integration of a rechargeable battery for the event of “no power” (bridging for approximately 3 to 5 minutes).

The invention relates to an intelligent motor brake for a length/angle sensor of a work vehicle, in particular a crane, as a replacement solution for a mechanical spring system, and an electric, parameterizable solution responds flexibly to changing requirements of the application and helps reduce both costs and weight.

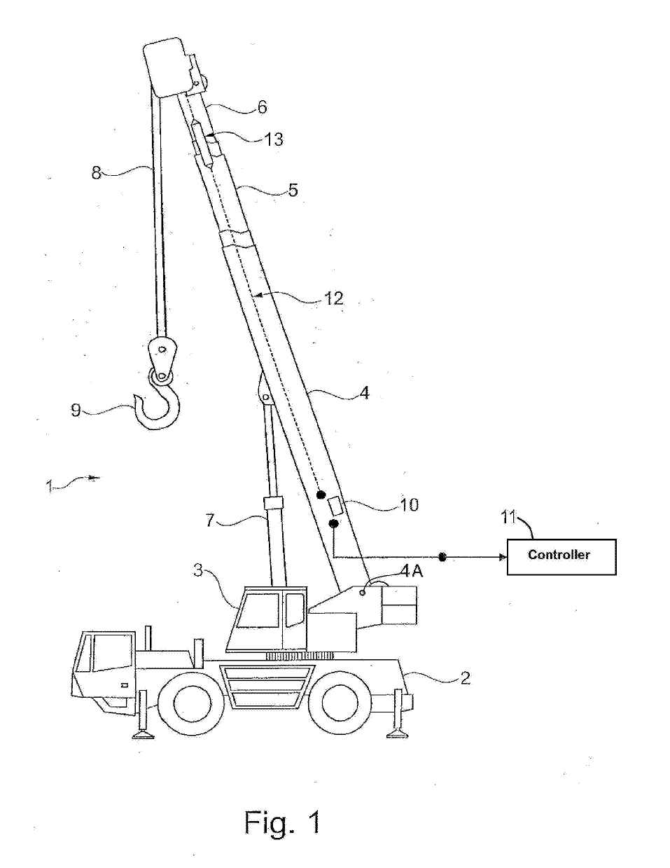

An embodiment of the invention is described below with reference to FIGS. 1 to 3.

In FIG. 1, to the extent that details are shown, reference numeral 1 denotes a crane that comprises a base 2 (including a drive for a moving about), for example, on which a rotary part 3 is mounted. A pivotable lower boom element 4 (base boom) is arranged on the rotary part 3 that in turn comprises further intermediate and upper boom elements 5, 6 (only one additional boom element or more than two boom elements also possible) so that the lower boom element 4 together with the intermediate and upper boom elements 5, 6 thereof can be telescoped in the manner known per se. This means that the length of the boom assembly 4-6 may vary, and this varied length must be detected for the safe operation of the crane 1. So as to be able to angle or pivot the lower boom element 4 relative to the base 2 or the rotary part 3, a hydraulic cylinder 7 is shown by example. Starting from a winch, which is not shown, on the rotary part 3, a rope 8 (crane rope) runs over the tip of the boom element 6 to a hook 9 hung from its end. A length/angle sensor 10 whose design is known per se is schematically shown and used to detect the length of the boom assembly 4-6 and pivot it relative to the rotary part 3 or the base 2. This length/angle sensor 10 is suitable and designed for detecting the angle of the lower boom element 4 relative to the rotary part 3 or the base 2 (not shown here). Reference numeral 11 denotes an output signal of the length/angle sensor 10 that is transmitted to an unillustrated controller. A cable 12 is present between the length/angle sensor 10 and, here, the tip of the boom element 6 for detecting the current length of the boom assembly 4-6. When the intermediate and upper boom elements 5, 6 are completely retracted, this cable 12 is rolled up in the length/angle sensor 10 and can unroll from a cable reel in the length/angle sensor 10 as the intermediate and upper boom elements 5, 6 are extended. This process is detected by the length/angle sensor 10 in the manner known per se, so that the output signal 11 transmits not only the angle of the lower boom element 4 to the controller, but also the current length of the lower boom element 4 together with the intermediate and upper boom elements 5, 6 thereof.

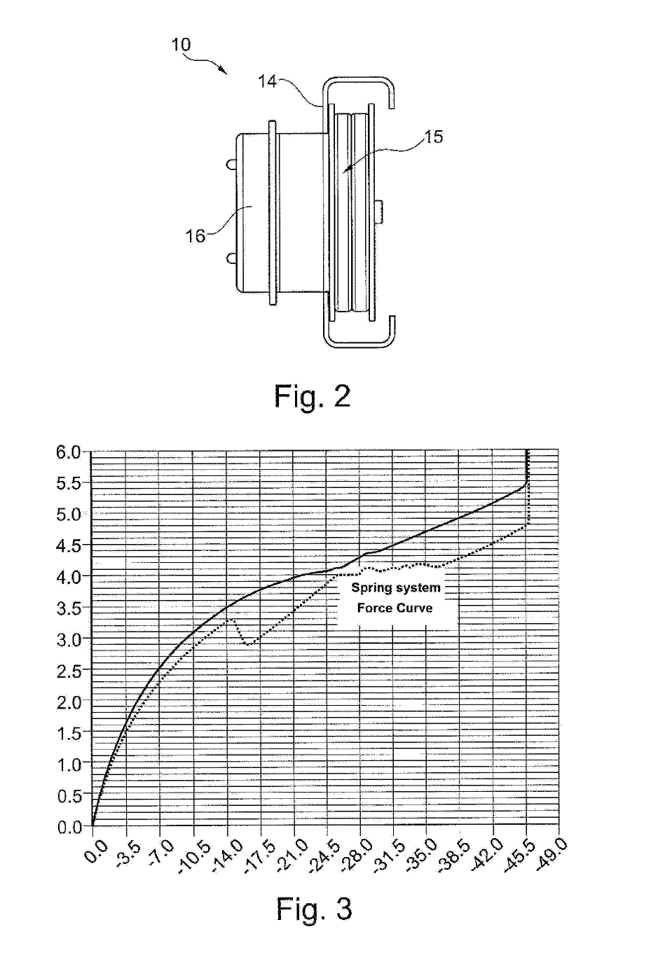

A force sensor 13 may be connected to the cable 12, but does not have to, and, in the illustrated embodiment according to FIG. 1, this force sensor 13 is along the cable 12 at the upper end region of the boom element 6 (which is to say at the boom tip). However, this is only one illustrated embodiment of a force sensor 13 and the arrangement thereof, and other locations in the progression of the cable 12 are also conceivable. While the force sensor 13 according to FIG. 1 directly detects the tension in the cable 12 in its longitudinal direction, force sensors that detect the force acting on the cable 12 indirectly (such as inductively) are also possible. Moreover, two identical or different force sensors may also be present from a safety-relevant perspective. The cable 12 is either designed in the manner known per se as a wire rope, so that it is necessary in this case to transmit the force acting on the cable 12 and detected at the boom tip via suitable means (see FIG. 2 in this regard). When the cable 12 is designed as a data cable, the force sensor 13 may be connected to the data cable in a simple manner, and the signals thereof can be transmitted in the direction of the rotary part 3, so that in this case the output signal 11 also includes the force acting on the cable 12.

FIG. 2 shows a basic design of a length sensor, in particular the length/angle sensor 10. A housing 14 holds all necessary components of the length sensor. This includes at least one reel 15 onto which the cable 12 is wound, or from which it is unwound, to determine the length. Moreover, an electric motor 16 is accommodated in the housing 14, the motor according to the invention replacing the previously known, spring based mechanical rewinding system. The housing 14 is in the lower boom element 4 and attached in a suitable manner. Moreover, the length sensor is connected to an unillustrated controller to which the output signals 11 are transmitted. Likewise, the length sensor may be supplied with energy for the operation of the motor 16 from the outside, in particular from the controller, and/or have its own power supply.

FIG. 3 shows two basic force curves in the cable 12 that can be set by appropriately setting or activating the motor 16 via the curve of the minimal (retracted) and maximal (completely extended) length of the telescopic boom assembly 4-6. It is also possible to set linear, or virtually linear, force progressions.

List of reference numerals:

| | |
|---|---|
| 1 | crane |
| 2 | base |
| 3 | rotary part |
| 4 | lower boom element |
| 5 | intermediate boom element |
| 6 | upper boom element |
| 7 | hydraulic cylinder |
| 8 | rope |
| 9 | hook |
| 10 | length/angle sensor |
| 11 | output signal |
| 12 | cable |
| 13 | force sensor |
| 14 | housing |
| 15 | reel |
| 16 | electric motor |

1. In a length/angle sensor of a crane, the sensor having a rewinding system including a reel and a cable that is wound onto this reel and can be unwound from this reel so as to detect a length, the improvement wherein the rewinding system comprises a controllable electric motor.

2. The length sensor according to claim 1, wherein a drive shaft of the motor is arranged connected directly to an axis of the reel.

3. The length sensor according to claim 1, wherein the motor is indirectly connected to the reel via a gearbox.

4. The length sensor according to claim 1, wherein the length sensor has a dedicated power supply.

5. A method of operating a a length/angle sensor of a crane, the sensor having a rewinding system and including a reel and a cable that is wound onto this reel and can be unwound from this reel so as to detect a length, the improvement wherein the rewinding system comprises a controllable electric motor and the motor is activated in such a way that a predetermined force progression of the cable is obtained when it is being unwound from the reel or wound onto the reel.

6. The method of operating a length sensor according to claim 5, wherein the motor is activated in such a way that a virtually constant force is applied to the cable when it is being unwound from the reel or wound onto the reel.

7. The method of operating a length sensor according to claim 5, wherein the force acting on the cable is measured by a force sensor.

8. The method of operating a length sensor according to claim 5, wherein rotation of the reel is detected by a rotation-speed sensor, the wound or unwound length of the cable being determined based thereon.

9. The method of operating a length sensor according to claim 5, wherein further operating parameters are considered for operating the motor.

10. A crane, comprising a base having a pivotable and telescoping lower boom element that includes at least one further boom element, and a length sensor according to claim 1 is provided that comprises at least one cable by which the respective length of the telescoping lower boom element is detected.

11. In a crane having a telescopic boom assembly pivotal about a horizontal axis and from which is hung a grab, a length/angle sensor comprising:
means in the boom assembly for detecting an angle formed by the boom assembly with the horizontal;
a rotatable reel in a lower region of the boom assembly;
a cable having an inner end wound around the reel and an outer end connected to the grab;
an electric motor connected to the reel and rotatable therewith; and
control means connected to the electric motor for rotating same in one rotational sense for winding up and tensioning the cable and in an opposite rotational sense for paying out the cable.

12. The length/angle sensor defined in claim 11, wherein the control means operates the motor to maintain a constant tension on the cable.

13. The length/angle sensor defined in claim 11, wherein the control means operates the motor to increase tension in the cable as the cable is payed out to prevent sagging of the cable.

14. The length/angle sensor defined in claim 11, wherein the motor is a direct-current motor, the sensor having a dedicated power supply connected to the motor for charging thereby during paying out of the cable.
